(19) United States
(12) Patent Application Publication
(10) Pub. No.: US 2002/0183892 A1
(43) Pub. Date: Dec. 5, 2002

(54) Method for booking stocks by using a stock operating system in a computer

(75) Inventors: Yeun-Jonq Lee, Hsin Tien City (TW); Yueh-Wen Chen, Hsin Tien City (TW); Yi-Hui Lin, Hsin Tien City (TW)

Correspondence Address: DOUGHERTY & TROXELL, SUITE 1404, 5205 LEESBURG PIKE, FALLS CHURCH, VA, 22041, US

(73) Assignee: Via Technologies, Inc.

(21) Appl. No.: 10/012,474

(22) Filed: Dec. 12, 2001

(30) Foreign Application Priority Data
May 30, 2001 (TW) 90113104

(51) Int. Cl. G06F 7/00

(52) U.S. Cl. 700/216

(57) ABSTRACT

A method for booking stocks by using a stock operation system in a computer comprises the steps of: a stock query information is firstly keyed into the stock operating system, wherein the stock query information includes the number or name of an item/product. Then, the stock operating system calculates statistically a offers and needs information of the item/product and shows the offers and needs information of the item/product on a monitor, where the offers and needs information of the item/product includes the information of the required quantity, booked quantity and lacked quantity of this item/product, etc. Subsequently, a stock adjustment information is keyed into the stock operating system, wherein the stock adjustment information includes the information for increase and reduction of the booked quantity of the item/product. If the sums of the available quantity and the booked quantity of this item/product before and after the stock adjustment information is keyed in are different, go back to the previous step to re-key in another stock adjustment information to the stock operating system. If the sum after the stock adjustment information is keyed in is not changed, the stock operating system will save up a new offers and needs information of this item/product after the stock adjustment information is keyed in.

### FIELD OF THE INVENTION

The present invention relates to an improved method for booking stocks by using a stock operating system in a computer, and more particularly to an improved method for booking stocks that is applied to the enterprise resource planning (ERP) system.

### DESCRIPTION OF THE PRIOR ART

The sale cycle of an enterprise is started from receiving a customer order. The salesperson confirms step by step the information of the customer order which includes customer credit audit and investigation, product stock query, and confirmation for whether the products and the quantity thereof which the customer needs can be provided before the deadline required by the customer, etc.

After the order is confirmed with the customer, it will then be handled by the production management (PM) personnel. The PM personnel periodically proceed with the calculation process of the material requirement planning (MRP) and make a production or purchasing planning for product items according to the customer's order requirements, and the company's sale prediction or production planning, so as to proceed with the production and/or purchasing process(es). After the production or purchasing is finished, the product items will be stored. On the date of goods outputting, the storekeeper lists all the order information of pre-delivery, and then proceeds with product choosing and outputting processes according to the present stocks quantity so as to finish the business exchange.

The stock management process in a general enterprise resource planning (ERP) system means that all product items are recorded in quantity according to the stock site, so as to be the basis for promising the delivery date of the customer order and purchasing at the purchasing department and production planning at the production department.

Concerning the sale order requirements, salespersons generally query the condition of product storage through the ERP system when receiving orders so as to reply the customer about the delivery date and the delivery quantity. However, most ERP systems can actually provide only the booked quantity of product storage as a reference to the production, counting, and sales systems, etc. The systems could not reflect the conditions of relevant operations, such as the part of undelivered products upon the committed order, the part of customer quotation request, and the parts already in the production planning, etc., in the stock quantity. This will cause that the system does not instantly reflect actual stock of insufficiency while many salespersons receive orders at the same time and also promise customers the delivery date at the same time. Finally, the shortage of stock is not found until the delivery process, and thus delivery in time is so impossible that a huge loss to the enterprise is resulted.

For few ERP systems, the users can choose whether to keep relevant stocks upon receiving orders, wherein the stock quantity of each product is booked in sequence in accordance with the order-receiving date. Although this kind of ERP systems provides a similar function of stock booking, if an important and urgent order happened to the system, it can not process delivery of that order since all the stocks are booked for the other orders, and then the user can only enter into the order process of the system to cancel the stocks booked for the other orders or to change the receiving date record in the system so that the system can rearrange the sequence of booked orders to put the less important orders behind the more important orders.

Now we cite one example to describe how the above-mentioned traditional stock management process in the ERP system proceeds with editing the booked stocks as below:

1. An item number METROT50-BPIS-HOTV (hereinafter named as the item X) has 80 pieces of stocks available in the storage currently (i.e. the maximum quantity the storage can supply is 80 pieces currently).

2. On Mar. 10, 2001, an order A of the item X is received and 40 pieces of delivery is expected on Mar. 26, 2001. Then, the order A is keyed in and proceeded with stock booking to reduce the available stocks in the storage to 40 pieces.

3. On Mar. 15, 2001, an order B of the item X is received and 30 pieces of delivery is expected on Mar. 31, 2001. Then, the order B is keyed in and proceeded with stock booking to reduce the available stocks in the storage to 10 pieces.

4. On Mar. 19, 2001, an order C of the item X is received and 30 pieces of delivery is expected on Mar. 22, 2001. Then, order C is keyed in and proceeded with stock booking to reduce the available stocks in the storage to −20 pieces.

5. On Mar. 19, 2001, 30 pieces of the order C should be delivered, but delivery cannot be processed due to insufficiency of the booked stocks in the storage. The salesperson must handle it urgently with the following steps:

(1) Enter into the order process system to release the booked stocks of the order A, and then the system re-edits the booked condition of stocks and the available stocks are increased to 40 pieces;

(2) Afterward, enter into the order process system again to re-book the stocks of the order C. During this period, if the available stocks are not used or booked by the other systems, the order C can then be kept with totally 30 pieces; and

(3) Then proceed with delivery of the order C.

Due to the fact that it does not open the direct adjustment function of booked storage in the storage management process in the above-mentioned traditional ERP system, the user has to process the complicated procedures as mentioned above to achieve the purpose that the goods flow controller can deliver important orders in higher priority. in another situation that on canceling the booked stocks of some orders, the available stocks may be right away booked by the other orders or systems because the book-cancelled stocks are unable to be directly appointed to a specific order, it still cause delivery unable to be proceeded.

In view of the above-mentioned drawbacks, how to solve the problems that may occur in the stock booking process for the stock management process of the traditional ERP system is apparently important.

### SUMMARY OF THE INVENTION

The primary object of this invention is to provide an improved method for booking stocks by using a stock operating system in a computer so as to achieve the purpose of automatic control and to update the current stocks used and booked in stock storages.

A first preferred embodiment of the improved stock booking method according to this invention includes the following steps:

Firstly, the requirement information of an item/product requirement form is keyed into a stock operating system, wherein the requirement information includes the required quantity of the item/product. Then the stock operating system finds out the available stocks of this item/product. If the available stocks of this item/product have a higher quantity than or an equal quantity to the required quantity of this item/product, the stock operating system will supply the item/product requirement form with a booked quantity that is equal to the required quantity of this item/product's from the available stocks of this item/product.

If the available stocks of this item/product have a smaller quantity than the required quantity of this item/product, the stock operating system executes at least the following steps: supplying a booked quantity that is equal to the quantity of the available stocks of the item/product for the requirement form of the item/product; and calculating the lacked quantity of the item/product as a reference of supplementing the quantity of this item/product where the lacked quantity is equal to the difference between the required quantity of the item/product and the available stocks.

The above-mentioned requirement form includes a customer quotation form, a sales order, a work form and a material required form. Moreover, the requirement information of the item/product requirement form further includes the appointed delivery storage of this item/product. In addition, the available stocks mean the maximum quantity of this item/product the delivery storage can supply.

Besides, the booked quantity includes an actual-booked quantity and a temporary-booked quantity, both of which are used to imply that the booked requirement forms are a valid requirement form and a not-yet-valid requirement form respectively. The not-yet-valid requirement form includes the customer quotation form and the valid requirement form includes the sales order, the work form and the material required form.

A second preferred embodiment of the improved stock booking method according to this invention includes the following steps:

Firstly, a stock query information is keyed into a stock operating system in a computer, wherein the stock query information includes the number or name of an item/product. Then, the stock operating system calculates statistically the offers and needs information of the item/product that is in correspondence with the requirements of the stock query information, and shows the offers and needs information of the item/product on a monitor, where the offers and needs information of the item/product includes the information of the required quantity, booked quantity and lacked quantity of this item/product, etc.

Subsequently, a stock adjustment information is keyed into the stock operating system, wherein the stock adjustment information includes the information for increase and reduction of the booked quantity of the item/product. Afterwards, the stock operating system will save up a new offers and needs information of this item/product after the stock adjustment information is keyed in.

Wherein the stock query information further includes requirement form categories of the item/product. And the stock query information further includes an appointed storage of stock adjustment of the item/product. Also, the offers and needs information further includes an available quantity of the item/product. Moreover, the stock adjustment information further includes an appointed storage of stock adjustment of this item/product and the information that parts or all of the available quantity of this item/product has been turned into the booked quantity.

Besides, the above-mentioned the requirement form categories include the customer quotation form, the sales order, the work form and the material required form. Moreover, the offers and needs information further includes the stocks quantity of this item/product in the storage. And the available quantity of the item/product refers to the maximum quantity of this item/product that the storage can supply.

Moreover, before the step that the stock operating system saves up a new offers and needs information of this item/product after the stock adjustment information is keyed in, the aforesaid method further includes execution of the following steps:

The stock operating system judges whether the sum of the available quantity and the booked quantity of this item/product before the stock adjustment information is keyed in, as compared with that after the stock adjustment information is keyed in, is changed or not. If the sums before and after the stock adjustment information is keyed in are different, another stock adjustment information is re-input into the stock operating system till the sums of the supply quantity and the booked quantity of this item/product before and after the stock adjustment information is keyed in are not changed.

Furthermore, the booked quantity includes an actual-booked quantity and a temporary-booked quantity, both of which are used to imply that the booked requirement forms are a valid requirement form and a not-yet-valid requirement form respectively. The not-yet-valid requirement form includes the customer quotation form and the valid requirement form includes the sales order, the work form and the material required form.

### BRIEF DESCRIPTION OF THE DRAWINGS

FIG. 1 is the querying page of booked stocks in the improved stock booking method according to one embodiment of this invention;

FIG. 2 is the adjustment page of sale booked stocks in the improved stock booking method according to the other embodiment of this invention;

FIG. 3 shows the flow chart of stock booking according to one preferred embodiment of this invention; and

FIG. 4 shows the flow chart of adjustment of booked stocks according to the other preferred embodiment of this invention.

### DESCRIPTION OF THE PREFERRED EMBODIMENT

The feature of this invention resides in providing an improved method about the procedures of the enterprise stock management process in order to simplify the procedures of the process.

In order to more effectively allocate the booked stocks, this invention divides the quantity of the booked stocks into two kinds: a temporary-booked quantity and an actual-booked quantity. If the quotation is only informed to the customer, the booked stocks quantity desired for the customer is recorded as the temporary-booked quantity. If the quotation has been arranged in the production planning or the order has been committed but not yet delivered, the booked stocks quantity desired for the customer is recorded as the actual-booked quantity. In this way, the current available quantity can be more accurately calculated, which not only sufficiently reflects the effects of the respective related systems on the stock, but also provides utilization to the respective related systems.

This invention further provides users to query each booked category about its total required quantity, total booked quantity and lacked quantity. It also opens the adjustment function to the booked stocks and shows the detailed booked condition of each receipt for users to adjust suitably according to the actual condition. The stock booking mechanism of this invention can be applied to the requirements such as the sales order, the work form or the material required form. Take example by the sales order requirement to describe the stock booking mechanism of this invention as below:

A. Handling of Temporary-Booked Stocks:

The system according to this invention processes the quotation products to be temporary-booked stocks based on the expired date of delivery appointed by the customer after the customer quotation process, which is indicated as the temporary stock booking process. On customers' officially ordering, the temporary-booked stocks will then be turned into the actual-booked stocks.

Also, the distinction between the actual-booked stocks and the temporary-booked stocks is that the temporary-booked stocks are usually with a valid date for booking, that is, if the customer does not reply whether to commit the order within the valid date, the system will then automatically cancel the temporary-booked stocks.

B. Handling of Actual-Booked Stocks:

The system according to this invention will automatically find out the current available stocks of the product in the delivery storage according to the delivery storage appointed on the sales order after confirming the sales order, and the system will then judge if the available stocks are sufficient for the required quantity of the order.

If they are sufficient, the stocks of the quantity needed by the customer will be booked for the sales order; if they are not sufficient, the current available quantity will be all left to the sales order and as to the part of the quantity lacked, another production management module will proceed with the MRP calculation to decide whether to purchase, produce or allocate that part, and it will be turned into the booked quantity of the order automatically after the production is finished or the purchasing/allocation is stored.

C. Handling of Adjustment to the Booked Stocks:

After the above-mentioned handling of booked stocks is done (including handling of booked stock raised by the requirements of the customer order, the work form or the material required form etc.), this invention also provides the goods flow controllers to query the stock condition of each product in each storage and to calculate statistically the information about the total required quantity, total booked stocks quantity and total lacked quantity etc. of each booked category for reference.

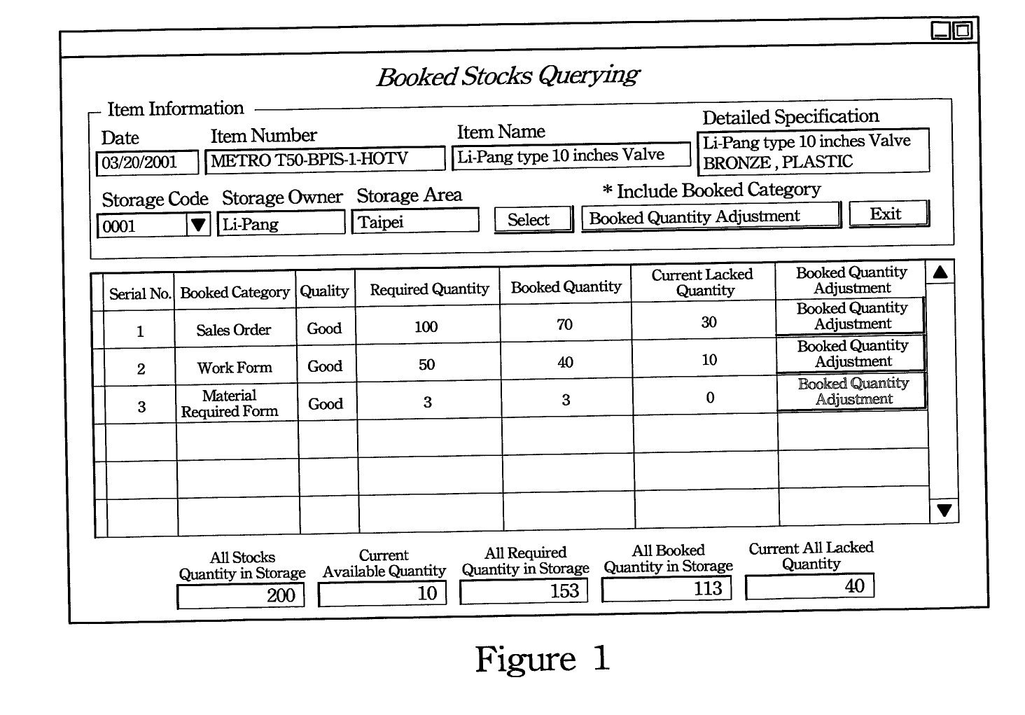

For example, in the page of “booked stocks querying” (please refer to FIG. 1) of this invention, the users can input the queried item number/name and select the storage. After the select button is pushed, the system will then calculate statically each booked category's required quantity, booked quantity and the condition of the current lacked quantity, and show the above information on the page of “booked stock querying.”

From FIG. 1, it is shown on the booked category of “sales order,” its required quantity, booked quantity, and current lacked quantity are 100, 70 and 30 pieces respectively. Also, it is shown of 10 pieces of “current available quantity” in the storage, and it will promote the efficiency of stocks utilization if that can be booked for the “sales order” or the “work form” to use.

When the available stocks are insufficient or comes a very important order that needs to be delivered urgently, the goods flow controller or salesperson can also review the condition of the orders and the stocks in the information system, and re-arrange the condition of the booked stocks by adjusting in detail the booked stocks quantity of each booked category (e.g. the sales orders).

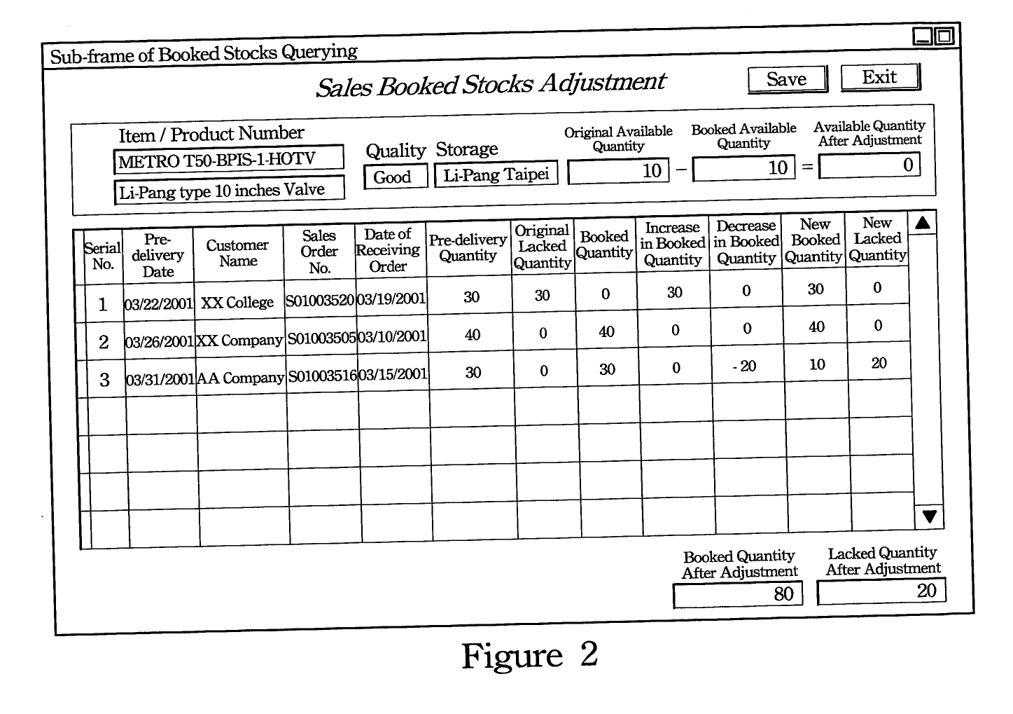

For instance, in the above-mentioned page of “booked stocks querying” provided by this invention (please refer to FIG. 1), after pushing the “booked quantity adjustment” button according to the booked category (herein the booked category of “sales order” is chosen as an example for illustration), the users can enter into the page of “sales booked stocks adjustment” (please refer to FIG. 2).

In this page of “sales booked stocks adjustment”, the users can enter in the intended adjustment of “increase in booked quantity” or of “decrease in booked quantity” in the column of “increase in booked quantity” or “decrease in booked quantity” of the page according to the level of importance of each sales order. The booked quantity increased by users has to be originally from: (1) substitution of the booked quantity of the other sales orders, and (2) the current available stocks.

Therefore, after the users key in the intended adjustment of “increase in booked quantity” or of “decrease in booked quantity” in the column of “increase in booked quantity” or “decrease in booked quantity,” the system has to check if the numerals of the booked quantity and the available quantity after adjustment are reasonable. If the numerals of the booked quantity and the available quantity after adjustment are reasonable, the system will save them up; otherwise the system will automatically suggest the users to re-adjust.

In the FIG. 2, there are three orders in the booked category of “sales order”: XX college, XX company, AA company. In XX college, its pre-delivered quantity (i.e. Required quantity), original lacked quantity and booked quantity are 30, 30 and 0 pieces respectively, and the booked stocks adjustment processed by the users is “30 pieces increase in booked quantity.” Also, in AA company, its pre-delivered quantity (i.e. Required quantity), original lacked quantity and booked quantity are 30, 0 and 30 pieces respectively, and the booked stocks adjustment processed by the users is “20 pieces decrease in booked quantity”. As for XX company, its pre-delivered quantity (i.e. Required quantity), original lacked quantity and booked quantity are 40, 0 and 40 pieces respectively, and the users do not make any adjustment to the booked stocks thereof.

So the “booked quantity after adjustment” calculated by the system=XX college's “new booked quantity”+AA company's “new booked quantity”+XX company's “new booked quantity”=(0+30) pieces+(40+0) pieces+(30−20) pieces=30 pieces+40 pieces+10 pieces=80 pieces. And the “lacked quantity after adjustment” calculated by the system=XX college's “new lacked quantity”+AA company's “new lacked quantity”+XX company's “new lacked quantity”=(30−30) pieces+(40−40) pieces+(30−10) pieces=0 pieces+0 pieces+20 pieces=20 pieces. The booked quantity of the “sales order” increased by the users is 10 pieces (i.e. the different amount between 80 pieces of the “booked quantity after adjustment” and 70 pieces of the original “booked quantity”), which is provided by the “current available quantity” in the storage of FIG. 1. In FIG. 2, it shows that 10 pieces of the original available quantity (i.e. the “current available quantity” in the storage of FIG. 1) has been all turned into the booked quantity (i.e. the “booked available quantity” of FIG. 2) increased to the “sales order”, so the available quantity after adjustment is zero.

The improved stock booking method of this invention provides mainly two functions: automatically executing stock booking and adjusting booked stocks, both of which can be done separately.

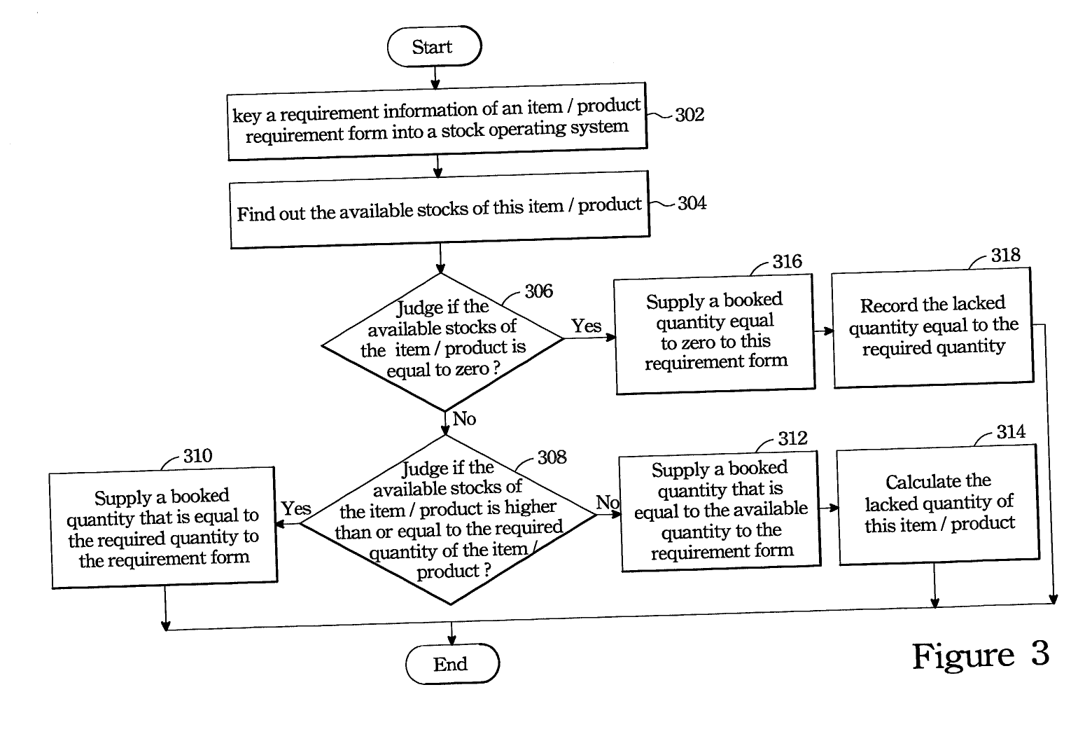

According to one of the preferred examples of the improved method for booking stocks in this invention, the procedures of booking stocks (please refer to FIG. 3) include the following steps:

Firstly, the requirement information of an item/product requirement form is keyed into a stock operating system, wherein the requirement information includes the appointed delivery storage and the required quantity of the item/product (step 302). Then, the stock operating system finds out the available stocks of this item/product in this delivery storage (step 304). Subsequently, the stock operating system judges if the available stocks of the item/product in this delivery storage are equal to zero (step 306) and if the available stocks are higher than or equal to the required quantity of the item/product (step 308).

If the available stocks of this item/product in this delivery storage are not equal to zero, and are higher than or equal to the required quantity of this item/product, the stock operating system will supply the item/product requirement form with a booked quantity that is equal to the required quantity of this item/product's from the available stocks of this item/product in this delivery storage (step 310).

If the available stocks of this item/product in this delivery storage are not equal to zero and smaller than the required quantity of this item/product, the stock operating system executes at least the following steps: supplying a booked quantity that is equal to the quantity of the available stocks of the item/product in this delivery storage for the requirement form of the item/product (step 312); and calculating the lacked quantity of the item/product in this delivery storage (step 314) as a reference for supplementing the quantity of this item/product in this delivery storage, where the lacked quantity is equal to the difference between the required quantity of the item/product and the available stocks in this delivery storage.

If the available stocks of this item/product in this delivery storage is equal to zero, this stock operating system supplies a booked quantity that is equal to zero for the requirement form of the item/product (step 316) and records the lacked quantity of this item/product in this delivery storage to be equal to the required quantity of this item/product (step 318), as a reference for supplementing the quantity of this item/product in this delivery storage

The above-mentioned requirement form includes a customer quotation form, a sales order, a work form and a material required form. And the part of the lacked quantity can be processed by another production management module with the MRP calculation to decide whether to purchase, produce or allocate that part. After production being finished or purchasing/transferring and allocation being stored, the lacked quantity will automatically turn into the booked quantity of the requirement form.

Also, the above-mentioned booked quantity includes a temporary-booked quantity and an actual-booked quantity. If the requirement form is a sales order and its quotation is only informed to the customer, the booked stocks quantity desired for the customer is recorded as the temporary-booked quantity; and if the requirement form is a sales order and it has been scheduled in the production planning or the order has been committed but not yet delivered, the booked stocks quantity desired for the customer is recorded as the actual-booked quantity.

Besides, the actual-booked quantity and the temporary-booked quantity are used to refer that the booked requirement forms are a valid requirement form and a not-yet-valid requirement form respectively. The not-yet-valid requirement form includes the customer quotation form and the valid requirement form includes the sales order, the work form and the material required form.

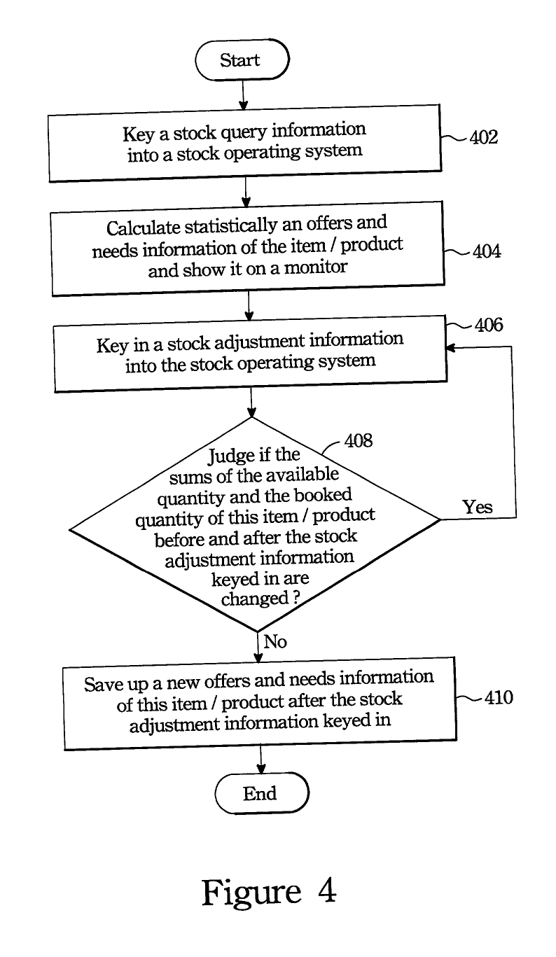

According to one of the preferred examples of the improved stock booking method provided by this invention, the procedure of booked stocks adjustment (please refer to FIG. 4) includes the following steps:

Firstly, a stock query information is keyed into a stock operating system in a computer (step 402), wherein the stock query information includes the number or name of the item/product. Then, the stock operating system calculates statistically the offers and needs information of the item/product that is in correspondence with the requirements of the stock query information, and shows the offers and needs information of the item/product on a monitor (step 404) where the offers and needs information of the item/product includes the information of the required quantity, booked quantity and lacked quantity of this item/product, etc.

Subsequently, a stock adjustment information is keyed into the stock operating system, wherein the stock adjustment information includes the information for increase and reduction of the booked quantity of the item/product (step 406). Then the stock operating system judges whether the sum of the available quantity and the booked quantity of this item/product before the stock adjustment information is keyed in, as compared with that after the stock adjustment information is keyed in, is changed or not (step 408).

If the sums before and after the stock adjustment information is keyed in are different, go back to step 406 to re-key in another stock adjustment information to the stock operating system.

If the sum of the available quantity and the booked quantity of this item/product after the stock adjustment information is keyed in is not changed, the stock operating system will save up the offers and needs information of this item/product after the stock adjustment information is keyed in (step 410).

Wherein the stock query information further includes the requirement form categories of the item/product. And the stock query information further includes the appointed storage of stock adjustment of the item/product. Also, the above-mentioned offers and needs information further includes the available quantity of the item/product. Moreover, the stock adjustment information further includes the information that parts or all of the available quantity of this item/product in the appointed storage of stock adjustment of this item/product has been turned into the booked quantity.

Besides, the above-mentioned requirement form categories include the customer quotation form, the sales order, the work form and the material required form. Moreover, the offers and needs information further includes the stock quantity of this item/product in the storage. And the available quantity of the item/product refers to the maximum quantity of this item/product that the storage can supply. In addition, the booked quantity includes an actual-booked quantity and a temporary-booked quantity, both of which are used to imply that the booked requirement forms are a valid requirement form and a not-yet-valid requirement form respectively. The not-yet-valid requirement form includes the customer quotation form and the valid requirement form includes the sales order, the work form and the material required form.

As a conclusion, this invention improves the defects of the general ERP system, and provides a better stock booking mechanism that can automatically control and renew the current conditions of using and booking stocks. The features of this invention, the problems solved and the advantages achieved beyond the conventional technique are described as below:

(1) Systematically recording the stocks allocation of each related system:

After the requirements of the sales order, the work form and the material required form etc. appear and are confirmed, the present invention executes the stock booking handling right away and records the used and booked conditions of each kind of requirements of all stocks, so as to closely connect the relations between the order or other requirements and the stocks.

It will help salespersons not only to access correct stocks conditions while receiving orders and to promise customers the exact delivery date, but also to confirm the practice conditions of each order after the order committed so as to avoid the condition that on the pick up of stocks, the stocks are found to have been transferred by the other processes or orders for use. It also helps production management personnel to know the condition of stocks utilization of each product item so as to predict exactly the items and the capability required.

(2) Simplified adjustment procedure of booked stocks:

When the available stocks are not enough and in the condition of an interruptive order or an emergent delivery, the users need not go through indirect and complicated procedures (for example, related booked stocks should be cancelled firstly, and the important orders can then be booked for etc.), and have only to enter into the page of “booked stocks adjustment,” where the stocks utilization can be easily and adequately re-allocated.

This simplified booked stocks adjustment procedure is mainly with two kinds: one is, on the basis of each booked category, to adjust the booked condition of each order considering the factors such as the importance of each order and customer, or the expected delivery date etc. in order to ensure achieving the purpose that the important orders can be delivered in first priority. The other one is, without restriction on the booked categories, to show all the stock booking processes of each system on the page so that the users can easily adjust the stocks booked conditions of different booked categories.

(3) Stocks information fully reflecting the actual situation:

This invention provides the temporary-booked, the actual-booked quantity and the current available quantity toward production and sales etc. related systems. It can fully reflect not only the effect of each related system on the stocks, but also the condition of each related system through the stocks information provided by the stocks files.

(4) This invention provides the users to query rapidly and in time the total required quantity of each booked category, such as the sales order, in each storage for all the product items, and the total lacked quantity that is statistically calculated by deducting the total booked quantity from the total required quantity, so as to check whether any product item is in shortage.

As is understood by a person skilled in the art, the foregoing embodiments of the present invention are illustrated of the present invention rather than limiting of the present invention. It is intended to cover various modifications and similar arrangements included within the spirit and scope of the appended claims, the scope of which should be accorded the broadest interpretation in order to encompass all such modifications and similar structure.

What is claimed is:

1. A method for booking stocks by using a stock operating system in a computer, said method comprising the steps of:
inputting a requirement information of an item/product requirement form into said stock operating system, wherein said requirement information comprises a required quantity of said item/product;
finding out available stocks of said item/product by said stock operating system;
supplying a booked quantity equal to said required quantity of said item/product from said available stocks of said item/product for said requirement form of said item/product by said stock operating system, if said available stocks of said item/product are higher than or equal to said required quantity of said item/product; and
executing at least the following steps by said stock operating system if said available stocks of said item/product are smaller than said required quantity of said item/product:
supplying a booked quantity equal to said available stocks of said item/product to said item/product requirement form; and
calculating a lacked quantity of said item/product as a reference for supplementing the quantity of said item/product, wherein said lacked quantity is equal to the difference between said required quantity of said item/product and said available stocks of said item/product.

2. The method according to claim 1, wherein said requirement form comprises a customer quotation form, a sales order, a work form and a material required form.

3. The method according to claim 1, wherein said requirement information of said item/product requirement form further comprises an appointed delivery storage of said item/product.

4. The method according to claim 3, wherein said available stocks means that the maximum quantity of said item/product said delivery storage can supply.

5. The method according to claim 1, wherein said booked quantity comprises an actual-booked quantity and a temporary-booked quantity, both of which are adapted to refer that said booked requirement forms are a valid requirement form and a not-yet-valid requirement form respectively.

6. The method according to claim 5, wherein said not-yet-valid requirement form comprises said customer quotation form.

7. The method according to claim 5, wherein said valid requirement form comprises said sales order, said work form and said material required form.

8. A method for booking stocks by using a stock operation system in a computer, said method comprising the steps of:
inputting a requirement information of an item/product requirement form into said stock operating system, wherein said requirement information of said item/product requirement form comprises an appointed delivery storage and a required quantity of said item/product;
finding out available stocks of said item/product in said delivery storage by said stock operating system;
supplying a booked quantity equal to said required quantity of said item/product from said available stocks of said item/product in said delivery storage for said requirement form of said item/product by said stock operating system, if said available stocks of said item/product in said delivery storage are greater than zero and higher than or equal to said required quantity of said item/product;
executing at least the following steps by said stock operating system if said available stocks of said item/product in said delivery storage are greater than zero and smaller than said required quantity of said item/product:
supplying a booked quantity equal to said available stocks of said item/product in said delivery storage to said item/product requirement form; and
calculating a lacked quantity of said item/product in said delivery storage as a reference for supplementing the quantity of said item/product in said delivery storage, wherein said lacked quantity is equal to the difference between said required quantity of said item/product and said available stocks of said item/product in said delivery storage; and
supplying a booked quantity that is equal to zero for said requirement form of said item/product and recording said lacked quantity of said item/product in said delivery storage to be equal to said required quantity of said item/product by said stock operating system, as a reference for supplementing the quantity of said item/product in said delivery storage, if said available stocks of said item/product in said delivery storage is equal to zero.

9. A method for booking stocks by using a stock operation system in a computer, said method comprising the steps of:
keying a stock query information into a stock operating system, wherein said stock query information comprises an item/product's number/name;
calculating statistically a offers and needs information of said item/product corresponding to the requirements of said stock query information by said stock operating system, wherein said offers and needs information of said item/product comprises the information of said item/product's required quantity, booked quantity and lacked quantity;
keying a stock adjustment information into said stock operating system, wherein said stock adjustment information comprises the increase and decrease information of said booked quantity of said item/product's; and
saving up a new offers and needs information of said item/product by said stock operating system after said stock adjustment information is keyed in.

10. The method according to claim 9, wherein said stock query information further comprises the requirement form category of said item/product.

11. The method according to claim 10, wherein said requirement form category comprises a customer quotation form, a sales order, a work form and a material required form.

12. The method according to claim 10, wherein said booked quantity comprises an actual-booked quantity and a temporary-booked quantity, both of which are adapted to refer that said booked requirement forms are a valid requirement form and a not-yet-valid requirement form respectively.

13. The method according to claim 12, wherein said not-yet-valid requirement form comprises said customer quotation form.

14. The method according to claim 12, wherein said valid requirement form comprises said sales order, said work form and said material required form.

15. The method according to claim 9, wherein said stock query information further comprises an appointed storage of stock adjustment of said item/product.

16. The method according to claim 9, wherein said offers and needs information further comprises the available quantity of said item/product.

17. The method according to claim 16, wherein said stock adjustment information further comprises an appointed storage of stock adjustment of said item/product.

18. The method according to claim 17, wherein said available quantity of said item/product means that the maximum quantity of said item/product said storage can supply.

19. The method according to claim 9, wherein said stock adjustment information further comprises the information that all or part of said available stocks of said item/product are transferred to said booked quantity.

20. The method according to claim 9, wherein said method further comprises executing at least the following steps before the step of saving up a new offers and needs information of said item/product by said stock operating system after said stock adjustment information is keyed in:
judging whether the sum of said available quantity and said booked quantity of said item/product before said stock adjustment information is keyed in, as compared with that after said stock adjustment information is keyed in is changed or not by said stock operating system; and
re-keying in another stock adjustment information to said stock operating system, if said sum of said available quantity and said booked quantity of said item/product after said stock adjustment information is keyed in is different from that before said stock adjustment information is keyed in, till said sums of said available quantity and said booked quantity of said item/product before and after said stock adjustment information is keyed in are not changed.
